(19) United States
(12) Patent Application Publication
(10) Pub. No.: US 2010/0045188 A1
(43) Pub. Date: Feb. 25, 2010

(54) ADJUSTING A DRIVING SIGNAL FOR SOLID-STATE LIGHTING DEVICES

(75) Inventors: Bernd Ackermann, Aachen (DE); Achim Hilgers, Alsdorf (DE); Christoph Martiny, Aachen (DE); Xiaoyan Zhu, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/519,391

(22) PCT Filed: Dec. 14, 2007
(86) PCT No.: PCT/IB07/55122

§ 371 Date: Jun. 16, 2009

(30) Foreign Application Priority Data
Dec. 20, 2006 (EP) 06126680.5

(51) Int. Cl. H05B 37/02

(52) U.S. Cl. 315/149

(57) ABSTRACT

Adjusting a driving signal for a lighting device by obtaining a temperature of the lighting device, and adjusting at least one parameter of a conversion procedure depending on the obtained temperature. Further a set-point of a desired colour and/or brightness is converted into a set-point of colour sensor coordinates with the conversion procedure. The actual colour values of the lighting device are obtained, and the driving signal is adjusted based on a difference between the colour sensor coordinates set-point and the obtained colour values.

### TECHNICAL FIELD

The present patent application relates to solid-state lighting and methods for adjusting a driving signal for lighting devices.

### BACKGROUND

During the last few years solid-state lighting devices based on additive colour mixing became more important. These lighting devices consist of light emitting diodes (LEDs), organic light emitting diodes (OLEDs) or a mixture of these, and in many application red, green and blue LED arrays are employed. Such lighting devices are applied in different units, e.g. LCD backlighting or white LED lamps. They provide high efficiency and high colour rendering indices.

Such a lighting device requires colour control systems to achieve colour point accuracy for illumination. Some kinds of these lighting devices use colour coordinates feedback schemes for controlling their light output. These schemes seem to be particular suitable, but they offer colour errors as a function of temperature.

Another controlling scheme is described in the international patent application WO 2006/011108 wherein a system is disclosed with a combined flux feedback and temperature feed forward scheme for controlling light output of a solid-state lighting device. The actual temperature of a heat sink is measured and converted into a first luminous flux signal. A sensor senses the light output and generates a second luminous flux signal for compensating the first luminous flux signal. The compensating unit generates a driving signal for driving the lighting device. However, the luminous flux feedback scheme does not provide good colour point accuracy.

Therefore, it is an object of the present application to provide a significant improvement of colour control accuracy. It is a further object of the present application to provide a significant reduction of colour errors.

### SUMMARY

These and other objects are solved by a method for adjusting a driving signal for a lighting device comprising obtaining a temperature of the lighting device, adjusting at least one parameter of a conversion procedure depending on the obtained temperature, converting a set-point of a desired colour and/or brightness into a set-point of colour sensor coordinates with the conversion procedure, obtaining actual colour values of the lighting device, and adjusting the driving signal depending on a difference between the colour sensor coordinates set-point and the obtained colour values.

It has been found that colour coordinates feedback schemes and a combination of flux feedback and temperature feed forward schemes are the most promising. Further it is discovered that colour feedback schemes compared to flux feedback schemes achieve better results.

A temperature of the lighting device may be obtained by measuring, whereby the temperature may be a single temperature or an averaged temperature of the lighting device. Based on the temperature at least one parameter of the conversion procedure may be adjusted. This may be used to convert a set-point for a desired colour and/or brightness into a set-point of colour sensor coordinates. This set-point of colour sensor coordinates may consist of tristimulus values. The emitted light may be given by its luminous flux and its chromaticity coordinates. These values can be easily transferred into tristimulus values. Therefore these values may cause a better result of colour point accuracy than luminous flux individually. Furthermore, the set-point of colour sensor coordinates may consist of the raw data of colour sensor readings. This means that tristimulus values are converted to raw data of sensor readings as part of the above mentioned conversion procedure. This approach has the advantage that raw data of sensor readings can be handled more efficiently than tristimulus values in the feedback loop.

Further the actual colour values may be obtained by a colour sensor. From the difference between the actually sensed colour values and the set-point, an error signal may be established. This function can be realised for example by a proportional-integral-derivative controller (PID controller). Hence, a driving signal is generated for driving the lighting device.

The colour and/or brightness vary depending on the temperature of the lighting device. To get a constant colour and/or brightness of the light output, the temperature is measured for adjusting the set-point of a desired colour and/or brightness. Because the temperature changes are significantly slower than the changes of the measured light output the adjustment may be made in a feed forward way. This leads to an easy implementation and it does not yield any problems of stability. Instead of this the colour values are led back by a feedback scheme for responding to changes of the measured light output in a sufficient way.

According to claim 2, it is preferred to obtain the temperature of the colour sensor unit. The colour sensor unit is a part of the lighting device and its temperature affects the relation between the raw data of its readings and tristimulus values of the light output of the lighting device. Usually, both the colour sensor unit and the LEDs are thermally coupled to a heatsink of the lighting device. Then the temperature of the heatsink and the LEDs may be inferred from the temperature of the colour sensor unit. Therefore, the temperature of the colour sensor unit can also be measured, which causes an even better accuracy of a desired colour point.

Further it is preferred setting the set-point of a desired colour and/or brightness by a user according to the method of claim 3. It is possible to use a plurality of different colours and/or brightness, which is set by a user. Through this the method can be applied in many different luminous applications with different colours and/or brightness.

For converting the set-point of a desired colour and/or brightness into a set-point of colour sensor coordinates, it is preferred to calibrate the parameters of the conversion procedure with initial parameters according to the method of claim 4. This may occur at the first starting for effective operation.

Another favourable embodiment according to claim 5 is to calibrate at different temperatures. For all possible temperatures accurate parameters are obtained by this way.

Furthermore, it is preferred to calibrate at least at two different temperatures, and obtaining the remaining parameters of the conversion procedure by interpolating. The remaining parameters are approximated values. This may reduce the cost for calibrating and it maintains a sufficient accuracy.

Alternatively already known calibrating data of lighting devices of similar design can be used for calibrating. This reduces the effort and accuracy is maintained in a sufficient manner. Some lamps of a production can be calibrated in detail and the remaining lamps will be calibrated with the averaged calibrating data of the exactly calibrated lighting devices. Furthermore, it is possible to calculate numerically the parameters from known features of the used LEDs.

According to the method of claim 6 it is preferred to obtain an averaged temperature of the lighting device. Thus it is not necessary to react on short-run fluctuations of the temperature with no effect to the colour or brightness.

A method for obtaining the temperature of the lighting device using a current-voltage characteristic of the lighting device is further preferred according to claim 7. The use of a temperature sensor may be omitted. The current-voltage voltage characteristic of the lighting device is mostly already known within the lighting device and therefore it is not laboriously to get the needed data.

Another favourable embodiment of the method according to claim 8 is to obtain the actual colour values of the lighting device by sensing with the peak sensitivity in different parts of a visible spectrum. The advantage consists of adjusting a desired sensitivity of the visible spectrum. The sensed data can be filtered by a low-pass filter to reduce the data. Thus the eye sensitivity may be emulated as well.

The different parts of the visible spectrum can be red, green and blue. These three fundamental colours are sensed by the human eye through its three different kinds of cones whereby every cone can detect one of these colours. Therefore, it is favourable to use these three parts for emulating the human sensitivity of the visible spectrum. The filter characteristics of the colour sensors may be tuned such that they are virtually identical to the eye sensitivity functions.

Compensating ageing of the lighting device by updating its calibration with the integrated sensors of the lighting device is further preferred according to claim 9. For maintaining the accuracy of a colour point the parameters are updated. This can be easily done with its own sensors without great costs.

A further preferred embodiment is to lead the driving signal back, and to rescale the set-point of a desired colour and/or brightness if the driving signal exceeds a predetermined signal threshold. If the driving signal increases this predetermined signal threshold saturation occurs. Leading the driving signal back and rescaling the set-point by limiting the brightness provides avoiding this effect. In addition the temperature of the lighting device can be used as an indicator for rescaling as well. Then, the temperature is also led back.

Another aspect of the patent application is a system for adjusting a driving signal for a lighting device comprising a temperature sensor unit for obtaining a temperature of the lighting device, a conversion procedure unit for converting a set-point of a desired colour and/or brightness into a set-point of colour sensor coordinates, a colour sensor unit for obtaining actual colour values of the lighting device, and a driving unit for adjusting the driving signal depending on a difference between the colour sensor coordinates set-point and the obtained colour values.

A further aspect is a computer program product tangibly embodied in an information carrier, the computer program product comprising instructions that, when executed, cause at least one processor to perform operations comprising obtaining a temperature of the lighting device, adjusting at least one parameter of a conversion procedure depending on the obtained temperature, converting a set-point of a desired colour and/or brightness into a set-point of colour sensor coordinates with the conversion procedure, obtaining actual colour values of the lighting device, and adjusting the driving signal depending on a difference between the colour sensor coordinates set-point and the obtained colour values.

Another aspect is a computer program for adjusting a driving signal for a lighting device the program instructions operable to cause a processor to obtain a temperature of the lighting device, adjust at least one parameter of a conversion procedure depending on the obtained temperature, convert a set-point of a desired colour and/or brightness into a set-point of colour sensor coordinates with the conversion procedure, obtain actual colour values of the lighting device, and adjust the driving signal depending on a difference between the colour sensor coordinates set-point and the obtained colour values.

These and other aspects of the present patent application will become apparent from and elucidated with reference to the following Figures.

### BRIEF DESCRIPTION OF THE DRAWINGS

In the Figures show:

FIG. 1 a system according to an embodiment

FIG. 2 a system according to a further embodiment

FIG. 3 a flowchart illustrating the adjusting of a driving signal for a lighting device

### DETAILED DESCRIPTION OF THE DRAWINGS

The present application provides for an improvement of colour control accuracy and a significant reduction of colour errors for solid-state lighting devices.

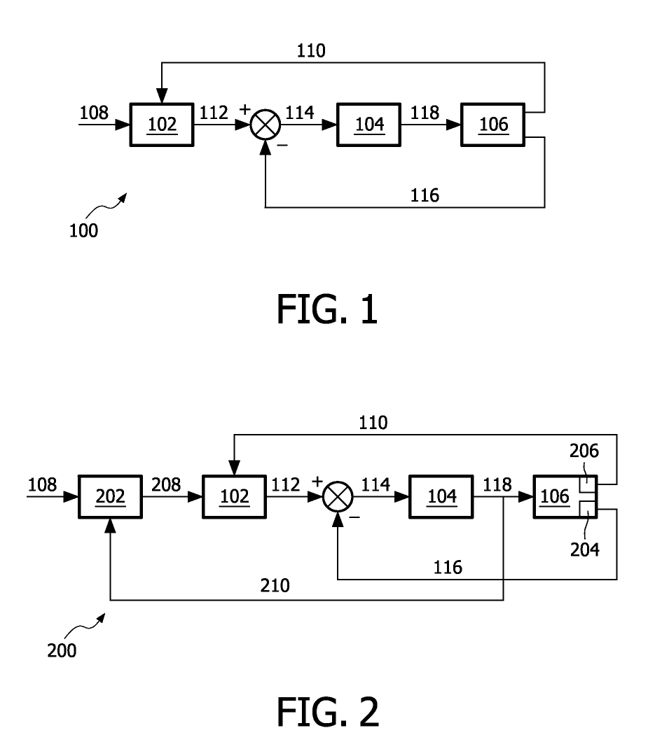

In FIG. 1 a system 100 of a first embodiment is illustrated. The system 100 comprises a conversion procedure unit 102 and a driving unit 104 which drives the lighting device 106. Furthermore, there are illustrated the set-point of a desired colour and/or brightness 108 and the converted set-point of colour sensor coordinates 112. In addition the colour sensor coordinates 116 of the actual values of the lighting device 106 and the built error signal 114 are also represented as the driving signal 118 and the temperature 110.

FIG. 2 shows a system 200 of a further embodiment of the present application. The already known units are not mentioned again and they hold the same designations as in FIG. 1. As a start a rescaling unit 202 is illustrated. Further the lighting device 106 comprises a temperature sensor unit 206 and a colour sensor unit 204. Illustrated is a limited set-point signal 208 as well as a controlling signal 210 of the driving signal 118. The temperature 110 is either the measured temperature of a heat sink of the lighting device 106 or the measured temperature of the LEDs or the measured temperature of the colour sensor unit 204 or a combination of these. The heatsink of the lighting device 106 is not illustrated.

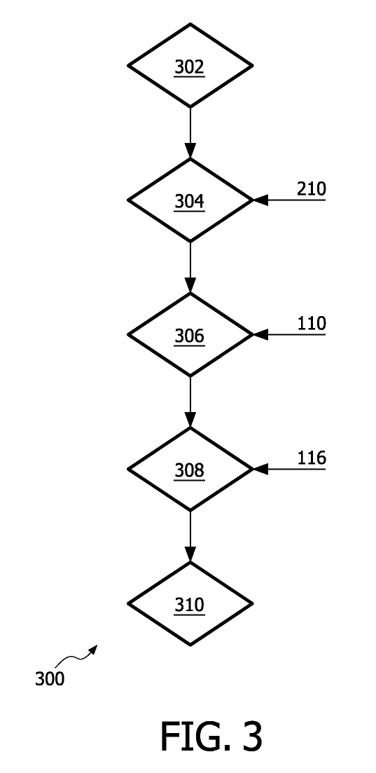

FIG. 3 illustrates a flowchart 300 for adjusting a driving signal 118 for a lighting device 106.

At the beginning the parameters of the conversion procedure unit 102 have to be obtained by calibrating. There exist several methods for calibrating which are not illustrated in the flowchart 300. After the calibration a user sets a desired colour and/or brightness set-point 108 in a first step 302.

In step 304 it is checked, if the controlling signal 210 surpasses a predetermined signal threshold. For this case the set-point of a desired colour and/or brightness 108 is limited in its brightness by the rescaling unit 202. This has to be done for avoiding a saturation of the driving signal 118. Otherwise the set-point of a desired colour and/or brightness 108 is forwarded to the conversion procedure unit 102 without limiting the brightness.

In the following step 306 the conversion occurs from the set-point of a desired colour and/or brightness 108 or the limited set-point signal 208 to a set-point of a colour sensor coordinates 112. Therefore, the temperature 110 of the lighting device 106 is sensed by a temperature sensor unit 206. Additionally the temperature 110 of the colour sensor unit 204 can be sensed by the temperature sensor unit 206 as well. The temperature 110 is directed to the conversion procedure unit 102 in a feed forward manner. Based on the temperature 110 and on an accurate previous calibration the set-points 108, 208 are converted into the set-point of a colour sensor coordinates 112.

The next step 308 includes adjusting the driving signal 118 for the lighting device 106. First, the colour values of the actual light output are obtained by a colour sensor unit 204 and the sensed colour sensor coordinates 116 are directed in a feedback way. This signal 116 is subtracted from the set-point of the colour sensor coordinates 112 with the result of an error signal 114. Depending on this signal 114 the driving unit 104 generates a driving signal 118 for driving the lighting device 106.

In the last step 310 the lighting device 106 emits light with high accuracy of a desired colour point.

While there have been shown and described and pointed out fundamental novel features of the invention as applied to a preferred embodiment thereof, it will be understood that various omissions and substitutions and changes in the form and details of the devices and methods described may be made by those skilled in the art without departing from the spirit of the invention. For example, it is expressly intended that all combinations of those elements and/or method steps, which perform substantially the same function in substantially the same way to achieve the same results, are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. It should also be recognised that any reference signs shall not be constructed as limiting the scope of the claims.

1. Method for adjusting a driving signal for a lighting device comprising:
obtaining a temperature of the lighting device,
adjusting at least one parameter of a conversion procedure depending on the obtained temperature,
converting a set-point of a desired colour and/or brightness into a set-point of colour sensor coordinates with the conversion procedure,
obtaining actual colour values of the lighting device, and
adjusting the driving signal depending on a difference between the colour sensor coordinates set-point and the obtained colour values.

2. Method of claim 1, wherein obtaining the temperature of the lighting device comprises obtaining a temperature of a colour sensor unit.

3. Method of claim 1, further comprising receiving a user input, and setting the set-point of a desired colour and/or brightness depending on the user input.

4. Method of claim 1, further comprising calibrating the parameters of the conversion procedure with initial parameters.

5. Method of claim 4, wherein calibrating the parameters of the conversion procedure comprises calibrating at different temperatures.

6. Method of claim 1, wherein obtaining the temperature of the lighting device comprises averaging the obtained temperature.

7. Method of claim 1, wherein obtaining the temperature of the lighting device comprises using a current-voltage characteristic of the lighting device.

8. Method of claim 1, wherein obtaining the actual colour values of the lighting device comprises sensing with the peak sensitivity in different parts of a visible spectrum.

9. Method of claim 1, further comprising compensating ageing of the lighting device by updating its calibration with the integrated sensors of the lighting device.

10. Method of claim 1, further comprising leading back the driving signal, and
rescaling the set-point of a desired colour and/or brightness if the driving signal exceeds a predetermined signal threshold.

11. System for adjusting a driving signal for a lighting device comprising:
temperature sensor unit for obtaining a temperature of the lighting device,
a conversion procedure unit for converting a set-point of a desired colour and/or brightness into a set-point of colour sensor coordinates,
a colour sensor unit for obtaining actual colour values of the lighting device, and
a driving unit for adjusting the driving signal depending on a difference between the colour sensor coordinates set-point and the obtained colour values.

12. Computer program product tangibly embodied in an information carrier, the computer program product comprising instructions that, when executed, cause at least one processor to perform operations comprising:
obtaining a temperature of the lighting device,
adjusting at least one parameter of a conversion procedure depending on the obtained temperature,
converting a set-point of a desired colour and/or brightness into a set-point of colour sensor coordinates with the conversion procedure,
obtaining actual colour values of the lighting device, and
adjusting the driving signal depending on a difference between the colour sensor coordinates set-point and the obtained colour values.

13. Computer program for adjusting a driving signal for a lighting device the program instructions operable to cause a processor to:
obtain a temperature of the lighting device,
adjust at least one parameter of a conversion procedure depending on the obtained temperature,
convert a set-point of a desired colour and/or brightness into a set-point of colour sensor coordinates with the conversion procedure,
obtain actual colour values of the lighting device, and
adjust the driving signal depending on a difference between the colour sensor coordinates set-point and the obtained colour values.
